(19) United States
(12) Patent Application Publication
(10) Pub. No.: US 2014/0250021 A1
(43) Pub. Date: Sep. 4, 2014

(54) SYSTEM AND METHODS FOR ISSUING A LICENSE PLATE AND REGISTRATION CARD FOR A VEHICLE

(71) Applicant: AVRS, Inc., Petaluma, CA (US)

(72) Inventors: Rick Francis, Pleasanton, CA (US); Robert Rieger, Novato, CA (US)

(73) Assignee: AVRS, Inc., Petaluma, CA (US)

(21) Appl. No.: 14/279,290

(22) Filed: May 15, 2014

Related U.S. Application Data
(63) Continuation-in-part of application No. 13/659,259, filed on Oct. 24, 2012.

(51) Int. Cl. G06Q 30/00

(52) U.S. Cl. CPC G06Q 30/018
USPC 705/317

(57) ABSTRACT

Systems and methods for issuing license plates and registrations for vehicles are provided. A method may provide for machine reading a license plate number and associating the license plate number with a set of data. The set of data my comprise identification information for a recently purchased vehicle, a name of a registered owner, a mailing and registration address for the registered owner, and a license plate identification sticker number. A set of documents related to the license plate, including a registration card, license plate identification sticker, and mailing label, may be printed.

### CROSS-REFERENCE TO RELATED APPLICATIONS

The present application is a continuation in part of U.S. patent application Ser. No. 13/659,259, filed on Oct. 24, 2012, titled “Document Tracking and Management System and Methods,” which is hereby incorporated by reference in its entirety.

### FIELD OF THE INVENTION

The present disclosure generally relates to a document system, and more particularly, to systems and methods for issuing license plates and registration cards for vehicles.

### BACKGROUND

Documents play an important role in virtually every industry. Documents provide, for example, evidentiary proof of the signatures of principal parties, proof of compliance with government or industry standards/regulations, and convey vital information. In an industry having multiple actors at different locations, documents are often transmitted between locations. It is, unfortunately, an all too common occurrence that the documents being mailed, shipped, etc., between such locations are lost, misdirected, and the like.

As an illustration, within the vehicle registration and driver licensing industry, physical documents are a necessary requirement to ensure compliance with, federal, state, and/or local laws and regulations, as well as to ensure ownership of vehicles is properly recorded. Generally, an individual desiring to obtain/renew a driver license or to title or register a vehicle (e.g., a car, a truck, a recreational vehicle, a watercraft, etc.) goes to his or her nearest tag agent and completes several mandatory documents. Exemplary mandated documents include, but are not limited to, an Application for Title or Registration, a Bill of Sale, an Odometer Disclosure Statement, Smog Certification, Safety Inspection Certification, etc. In some cases, the tag agent submits the completed title or registration documents to an independent party (may be referred to as a first line provider) for further submission to the Department of Motor Vehicles Agency (DMV). The DMV approves or rejects the documents and, if approved, records the registration.

However, current systems do not generally provide an effective procedure for accepting data associated with a recent purchase of a vehicle and delivering a required license plate and documentation to the vehicle purchaser. For example, presently known systems do not provide a means for the tag agent to monitor the location of the documents. Further, presently known systems do not provide an efficient mechanism wherein vehicle purchase data may be associated with a license plate. Further, present systems do not provide an efficient mechanism where the license plate associated with the vehicle purchase may be matched to a registration card and license plate identification sticker. Lastly, present systems do not provide an efficient mechanism for preparing the associated license plate, registration card, and license plate identification sticker to be mailed to the vehicle purchaser.

Thus, there is a need for an improved system for issuance of a license plate and registration card, such as is presently disclosed.

### SUMMARY OF THE INVENTION

According to various embodiments, a method for issuing a license plates and registration cards for vehicles is provided. The method may comprise selecting a license plate from a supply of license plates. The selected license plate may be placed within range of an optical scanning device that is capable of machine reading a license plate number on the selected license plate. A set of data may be associated with the license plate number of the selected license plate. In various embodiments, the set of data may comprise identification information for a recently purchased vehicle, a name of a registered owner of the recently purchased vehicle, a mailing address associated with the registered owner, a registration address associated with the registered owner, and a license plate identification sticker number. A set of documents may be printed that may comprise a registration card, a license plate identification sticker, and a mailing label.

Once the set of documents is printed, the selected license plate may be coupled with the set of documents such as by placing them in an envelope. The mailing label may be placed on the envelope, and the license plate and set of documents may be mailed or otherwise conveyed to the registered owner.

In accordance with additional embodiments, a method for issuing a license plates and registration cards for vehicles is provided. The method may comprise establishing a database of recently purchased vehicles. The database of recently purchased vehicles may comprise vehicle sales information from vehicle dealers. A set of data may be associated with each of the recently purchased vehicles in the database. The set of data may comprise a name of a registered owner of the recently purchased vehicle, a mailing address associated with the registered owner, a registration address associated with the registered owner, a license plate number, and a license plate identification sticker number.

A license plate may be selected from a supply of license plates. The selected license plate may be positioned within range of an optical scanning device that is capable of machine reading a license plate number on the selected license plate. The license plate number associated with the recently purchased vehicle and set of data may then be determined.

A set of documents may be printed that may comprise a registration card, a license plate identification sticker, and a mailing label. Each of the set of documents may have a variety of data from the set of data printed thereon. Once the set of documents is printed, the selected license plate may be coupled with the set of documents such as by placing them in an envelope. The mailing label may be placed on the envelope, and license plate and set of documents may be mailed or otherwise conveyed to the registered owner.

### BRIEF DESCRIPTION OF THE DRAWINGS

FIG. 1 is a block diagram illustrating certain aspects of the presently disclosed document tracking and management system and methods.

FIG. 2 is a block diagram of an exemplary provider system of the first line provider, in accordance with aspects of the present disclosure.

FIG. 3 is a flowchart of an exemplary method of providing document tracking and management, in accordance with aspects of the present disclosure.

FIG. 4 is a flowchart of another exemplary method of providing document tracking and management, in accordance with aspects of the present disclosure.

FIG. 5 is a flowchart of even another method of providing document tracking and management, in accordance with aspects of the present disclosure.

FIG. 6 is a schematic diagram of an exemplary architecture of a system for issuing a license plates and registration cards for vehicles according to various embodiments.

FIG. 7 is an exemplary flow chart of a method for issuing a license plates and registration cards for vehicles according to various embodiments.

FIG. 8 is an exemplary flow chart of a method for issuing a license plates and registration cards for vehicles according to various embodiments.

FIG. 9 is a block diagram of an exemplary computing system that may be utilized to practice aspects of the present disclosure according to various embodiments.

### DETAILED DESCRIPTION OF THE INVENTION

Before explaining the presently disclosed and claimed inventive concept(s) in detail by way of exemplary embodiments, drawings, and appended claims, it is to be understood that the present disclosure is not limited in its application to the details of construction and the arrangement of the components set forth in the following description or illustrated in the drawings. The present disclosure is capable of other embodiments or of being practiced or carried out in various ways. As such, the language used herein is intended to be given the broadest possible scope and meaning; and the embodiments are meant to be exemplary--not exhaustive. It is to be understood that the phraseology and terminology employed herein is for the purpose of description and should not be regarded as limiting. Unless otherwise required by context, singular terms may include pluralities and plural terms may include the singular.

The following description of the presently disclosed document tracking and management system is provided with reference to said system being implemented within the vehicle registration industry. As such, the description generally relates to the transfer and tracking of, and access to documents between at least one tag agent, an intermediary (i.e., a first line provider), and a DMV agency. However, it is to be understood that the present disclosure is not limited to the vehicle registration industry and is, instead, capable of being implemented in a variety of other industries. Such exemplary industries include, but are not limited to, the real estate industry (e.g., document tracking and management between agents, closing agents, inspectors, lending institutions, etc.), the banking industry (e.g., document tracking and management between lending institutions, clearing facilities, etc.) as well as any other industry which would benefit from the present disclosure.

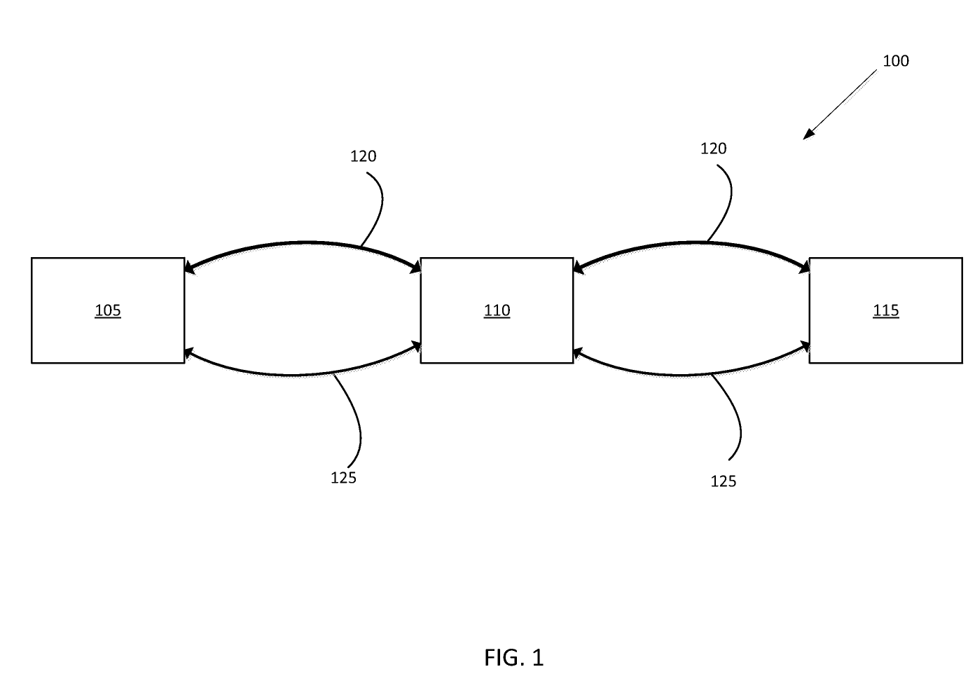

Referring now to FIG. 1, shown therein is a block diagram illustrating certain aspects of the presently disclosed document tracking and management system and methods. Generally, FIG. 1 illustrates a system 100 which may implement aspects of the present disclosure. The system 100 may comprise a remote user 105, a first line provider 110, and an end user 115. The remote user 105 and/or the end user 115 may communicate with the first line provider 115 via a communications channel 120. The remote user 105 and/or the end user 115 may exchange one or more physical documents, or a batch of documents via a path 125.

The remote user 105 may be a business authorized to process registration information, e.g., a tag agent. The remote user 105 may be authorized to prepare/complete state-mandated documents related to driver licensing as well as the titling and/or registration of a vehicle, e.g., a motor vehicle, a recreational vehicle, a sport utility vehicle, a watercraft, etc. Exemplary mandated documents include, but are not limited to, an Application for Title or Registration, a Bill of Sale, an Odometer Disclosure Statement, Smog Certification, Safety Inspection Certification, etc. Although one remote user 105 is shown in FIG. 1, it is to be understood that the present disclosure may comprise more than one, i.e., a plurality of remote users 105. The remote user 105 may comprise a remote user terminal (not shown) wherein, as the remote user 105 completes or prepares documents relating to such registration information, information is transmitted to the first line provider 115, via the communications channel 120, that is indicative of the nature of the completed documents, e.g., information indicative of a new registration for a recreational vehicle being issued to a first customer, information indicative of a renewal registration for a motorcycle being issued to a second customer, etc. The remote user terminal may comprise a communication mechanism adapted to permit the remote user 105 and the first line provider 110 to communicate via the communications channel 120. The communications channel 120 may be a private network of interconnected terminals or a public network, e.g., the Internet. The remote user terminal may be implemented as a point-of-sale terminal, a personal computer, a laptop, a smart phone, a terminal computer, etc.

The end user 115 may be a Department of Motor Vehicles Agency (DMV). The end user 115 may be a federal, state, and/or local agency authorized to approve or reject licensing, title, and/or registration information. For example, the end user 115 may be authorized to register a vehicle to a particular customer in response to the remote user 105 completing said registration information for the customer. Also, although one end user 115 is shown in FIG. 1, it is to be understood that the present disclosure may comprise more than one, i.e., a plurality of end users 115.

The path 125 may be configured to transfer, ship, or mail the physical documents between the parties, e.g., between the remote user 105 and the first line provider 110 and/or between the end user 115 and the first line provider 110. The path 125 may be implemented via the United States Postal Service, a third party carrier (e.g., Fedex®, UPS®, etc.), and/or a commercial or private courier service. The path 125 may be adapted to provide a tracking data with respect to the documents being transferred or shipped via the path 125. The tracking data may be a tracking identification number and include information indicative of the date/time and location from which the documents were shipped, the physical location of the documents as the documents transit along the path 125, and the date/time and location of the party receiving the documents.

The following exemplary operational description is provided by way of example only and is not to be considered limiting. In operation, the remote user 105 may be a tag agent that generates or otherwise prepares one or more documents for each transaction. For example, a vehicle registration renewal for a first customer may require the remote user 105 to prepare an Odometer Certificate, a Request for Registration, an Insurance Verification Certificate, etc. As the remote user 105 completes each transaction, or at the end of the day, information is provided to the first line provider 110 via the communications channel 120. The information may include data indicating that, for that business day, the remote user 105 has completed seven transactions (e.g., three vehicle registration renewals, two new vehicle registrations, and three licenses being issued) and that the remote user 105 has completed business for that day and is preparing to convey the documents to the first line provider 110. The documents generated by the remote user 105 for that day may be referred to as a first batch of documents. That is, a first batch of documents may refer to one or more documents being transmitted from the remote user 105 to the first line provider 110 via the path 125. Within the first batch of documents, there could be, for example, 5 documents for each vehicle registration renewal, 3 documents for each licenses being issued, etc. Collectively, the documents generated by the remote user 105 for a predetermined time period (e.g., one day, one week, one month, etc.) may be the first batch of documents.

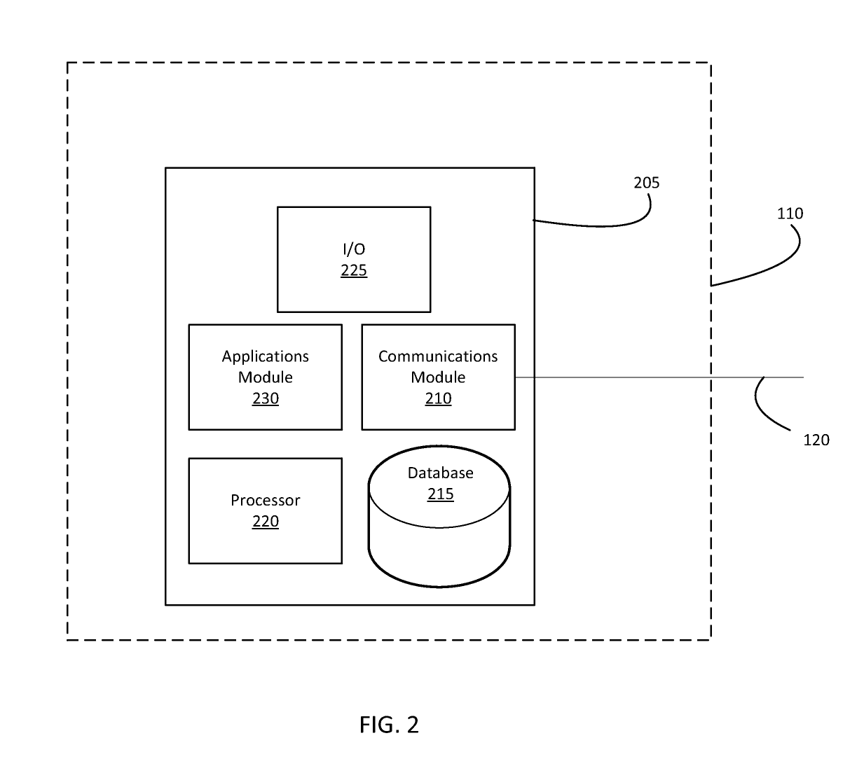

In response to the first line provider 110 receiving the information regarding the batch of documents from the remote user 105, the first line provider 110 may provide an identification data to the remote user 105. For example, the first line provider 110 may comprise a provider system (discussed in greater detail with reference to FIG. 2) that may generally be referred to as a computerized processing system (e.g., a server, a virtual server, a personal computer, laptop, etc.). The identification data may be automatically generated by the provider system and include a unique number that is associated with that particular batch of documents. In one example, the identification data may be implemented as a barcode. The identification data may include information indicating which remote user 105 generated the first batch of documents, what predetermined time period the first batch of documents was generated, etc. The remote user 105 may print a summary sheet that includes the identification data and attach, or otherwise associate the summary sheet to the first batch of documents so as to thereby associate the identification data to the first batch of documents. The remote user 105 then conveys the first batch of documents to the first line provider 110 via the path 125. For example, the remote user 105 may mail the first batch of documents with the associated identification data via the United States Postal Service.

The first batch of documents with the associated identification data is received at the first line provider 110. The first line provider 110 may utilize the provider system to input or otherwise record receipt of the first batch of documents from the remote user 105. As one example, the first line provider 110 may scan the identification data (e.g., barcode) upon initial receipt of the first batch of documents. The provider system may be configured to store information, in a document database, indicative of the specifics of the first batch of documents. That is, the provider system may store such exemplary information in the document database, for each batch of documents, as when the remote user 105 initially transmitted information to the first line provider 110 that the first batch of documents was generated, the date and time of when the first batch of documents was received by the first line provider 110, etc. The provider system may implement the document database as a SQL database wherein all of the information contained in the document database is readily accessible using, for example, the identification data.

Once the first line provider 110 has received the first batch of documents, various other functions can be performed at the provider 110 level. In accordance with certain aspects, the first line provider 110 may create an electronic file for each of the documents in the first batch of documents. In this case, the electronic file is associated with the identification data. For example, the first line provider 110 may scan each of the documents into the document database using a flatbed, or sheet feed scanner. The electronic files may be saved in the portable document format (pdf), as an image file (e.g., tiff, jpg, bmp, etc.), or other file format. The electronic file of the first batch of documents is stored in the document database and associated with the identification data. Associating each electronic file with the identification data in the document database may permit ready identification and retrieval of the file based on the identification data. That is, a user may query the document database using the identification data so as to identify the electronic file and retrieve the electronic file for presentation to the user. In one embodiment, the first line provider 110 may optionally process the electronic file using, for example, an optical character recognition (OCR) program or module. The OCR'd electronic file may then be word searchable such that a user may query the document database using, for example, a customer name, so as to identify and retrieve the electronic file. The user may also then query the document database using the identification data associated with the first batch of documents and also the customer's name to reduce the number of identified electronic file hits.

Once the first line provider 110 has entered information into the document database indicating receipt of the first batch of documents, the provider system may be configured such that the remote user 105 may access the document database so as to identify and be presented information associated with the first batch of documents. For example, the remote user 105 may query the document database using the identification data so as to be presented with information confirming receipt of the first batch of documents by the first line provider 110. The remote user 105 may also be permitted to retrieve the electronic files of the first batch of documents for viewing. In one example, the communications channel 120 is the Internet and the remote user 105 accesses the electronic files via one, or a series of web pages being provided by the provider system.

The first line provider 110 may then forward the first batch of documents to the end user 115. The tracking data may be stored in the document database and associated with the identification data. The first batch of documents may be forwarded to the end user 115 via the path 125. The tracking data may include information indicative of the first batch of documents being forwarded to, and received by the end user 115. As one example, the path 125 may be implemented via a commercial carrier (e.g., Fedex®) wherein the carrier provides the first line provider 110 a tracking identification number and access to real-time monitoring of the location of the first batch of documents as they progress from the location of the first line provider 110 to the location of the end user 115. The first line provider may, via the provider system, for example, store the real-time location of the first batch of documents in the document database as a part of the tracking data. When the first batch of documents is received by the end user 115, e.g., when an individual associated with the end user 115 signs for the first batch of documents, the document database may be updated to include information indicating when, and by whom the first batch of documents has been received by the end user 115. As mentioned above, the end user 115 may be a DMV agency and may process the documents, e.g., the DMV agency may review, approve, and record the registration of a vehicle associated with at least a portion of the documents included in the first batch of documents.

Further, the remote user 105 may access the document database using the identification data so as to be presented with the tracking data such that the remote user 105 and/or the first line provider 110 may have confirmation that the first batch of documents was received at the end user 115.

Another aspect of the presently disclosed document tracking and management system is the improved access to the electronic files and the tracking data for both the remote user 105 and the end user 115. That is, the first line provider 110 may provide access to the electronic files of the first batch of documents. The access may be provided via the communications channel 120 and may be based on the identification data. As one example, the remote user 105 and/or the end user 115 may access the provider system via the communications channel 120 and enter the identification data into a query module. The query module may search the document database to identify the electronic file and/or the tracking data associated with the identification data. As such, the remote user 105 and/or the end user 115 may be presented with information indicative of when (date/time) the first batch of documents being received by the first line provider 110, when the first batch of documents was forwarded to the end user, when the first batch of documents was received by the end user 115, and which individual associated with the end user 115 received (e.g., signed for) the first batch of documents. In situations where multiple parties are involved in a transaction, the presently disclosed document tracking and management system provides a one-stop system for each of the parties to access the flow of the documents through the process as well as confirmation of each parties completion of their respective step.

The remote user 105 and/or the end user 115 may also be provided access to the electronic files of the first batch of documents. The remote user 105 and/or the end user 115 may be provided access to the electronic files based on the identification data. That is, the remote user 105 and/or the end user 115 may access the provider system and enter the identification data as an input to a query module. The query module may search the document database to identify the electronic files associated with the identification data and present the electronic files to the requestor. As such, the remote user 105 and/or the end user 115 may be presented with a file that includes information indicative of each document in the first batch of documents. In one example, the electronic file may be an image (e.g., pdf, jpg, etc.) of the original document of the first batch of documents. In the case of the vehicle registration industry, the tag agent and/or the DMV agency may access the electronic files based on the identification data associated with the first batch of documents so as to, for example, confirm the presence of particular documents, print a copy of the original document, etc.

Other aspects of the present disclosure provide for the first line provider 110 to review the first batch of documents received from the remote user 105 to identify whether any document of the first batch of documents requires a corrective action. The review may include reviewing the first batch of documents to determine if any of the documents in the first batch of documents is missing, incomplete, etc. In the case of a vehicle registration, such a transaction may have state-mandated documents including a Request to Register a Vehicle, an Odometer Statement, a Smog Inspection, and a Insurance Verification Certificate. The first line provider 110 may, based on the initial information provided by the remote user 105 for the predetermined time period and the state-mandated forms for such transaction, review the first batch of documents to ensure that each required document is present, that each document is completed properly, that all the necessary signatures are present, etc. In the case where an error is identified, the first line provider 110 may communicate to the remote user 105 the corrective action. The corrective action may be communicated to the remote user 105 via the communications channel 120. The corrective action may be communicated to the remote user 105 as, for example, an email message, as a text message transmitted over a cellular telephone message, etc. The corrective action may include information indicating which documents are missing, which signatures are missing, which documents are completed improperly, etc. The remote user 105 may access the provider system using the identification data to review the electronic file of the first batch of documents, if desired. The remote user 105 may, in response to receiving the corrective action, remedy the error and then provide a correcting document to the first line provider 110. The correcting document may be associated with the identification data. The first line provider 110 may delay forwarding the first batch of documents to the end user 115 until the correcting document has been received and associated with the first batch of documents. That is, the first line provider 110 may hold the first batch of documents until the remote user 105 has an opportunity to provide the correcting document remedying the error. Once the correcting document has been received, the first line provider 110 may then forward the first batch of documents to the end user for processing. It is to be understood that mandatory deadlines covering the time period within which the end user must receive the first batch of documents may prevent the first line provider 110 from holding the first batch of documents for an indeterminable time. In this case, the first line provider 110 may then be forced to forward the first batch of documents to the end user 115 for processing.

Other aspects may provide for error data to be stored for each remote user 105. The error data may be stored by the first line provider 110. The error data may include information indicative of the frequency and type of corrective actions that are required for the remote user 105. The error data may be communicated to the remote user 105, wherein the remote user 105 analyzes the error data to identify particular areas that need to receive further training. For example, if the remote user 105 is a tag agent and five of the previous ten vehicle registration documents are missing the Smog Statement, said error data may include information indicating to that tag agent that additional training is required of its employees to ensure better compliance with the Smog Statement requirement. The error data may be stored in the document database, or a different database of the provider system of the first line provider 110. The error data may be forwarded to the remote user 105 via, for example, the communications channel 120.

With reference to FIG. 2, shown therein is a block diagram of an exemplary provider system 205 of the first line provider 110. The provider system 205 comprises a communications module 210, a document database 215, a processor 220, an Input/Output (I/O) 225, and an applications module 230. Broadly, the system 205 may be implemented as a processor-based computing system, e.g., a personal computer, a laptop, a smart phone, a netbook, etc. Other aspects may provide for the system 205 to be implemented as a real and/or virtual server, or a series of servers operating on a network environment and communicating over, for example, the Internet. The system 205 may be utilized by the first line provider 110 to implement aspects of the presently disclosed document tracking and management system.

The communications module 210 is configured, or otherwise adapted to communicate via the communications channel 120. The communications module 210 may be implemented as a network interface card operating on the system 205 and being configured to communicate with, for example, the remote user 105 via the communications channel 120. The system 205 may be adapted to transmit to and/or receive information from the remote user 105 and/or the end user 115, utilizing the communications module 210.

The document database 215 may be configured to store data, electronic files, variables, etc. Exemplary implementations of the document database 215 include, but are not limited to, a SEQUEL (SQL) database, collaborative database, etc. The document database 215 may include logic instructions such that the information stored thereon is managed in a relational database management system (RDBMS). The document database 215 may be implemented as a single database, or a plurality of databases in communication. Further, the document database 215 may be stored on a single storage device within the system 205 or may be distributed amongst multiple storage devices, e.g., one or more hard drives. Other aspects may provide for the document database 215 to be implemented via an online storage provider wherein the system 205 searches, stores, and retrieves information from the document database 215 via the communications module 210 communicating via the communications channel 120.

The processor 220 may comprise one or more processors adapted to execute computer-executable code provided by, for example, the applications module 230. The processor 220 may be in communication with other components of the system 205 via one or more system buses so as to exchange information, data, etc. The processor 220 may comprise an integrated memory component temporarily storing data, information, or variables being utilized in conjunction with the processor 220 executing instructions.

The applications module 230 may comprise one or more modules adapted to perform certain aspects of the presently disclosed document tracking and management system. The modules may be implemented as computer executable code that, when executed, cause the system 205 to carry out aspects of the presently disclosed document tracking and management system. The applications module 230 may include code stored on a memory device that is accessible by the processor 220 so as to be executed thereon. The applications module 230 may further include instructions or code configured to operate and/or control system-level functions of the system 205, e.g., data routing, operating system, etc.

In accordance with certain aspects, the applications module 230 may comprise a query module and a presentation module. The query module may permit, or be otherwise configured to, in response to receiving a request including the identification data from a user, identify an electronic file of a first batch of documents being stored in the document database 215. The query module may be in communications with the document database 215 so as to search the information stored therein to locate the first batch of documents, from amongst other batches of documents, the user seeks to locate. The presentation module may be configured to provide access to the user to the electronic file of the first batch of documents associated with the identification data. The presentation module may further provide access to the tracking data for the first batch of documents. The presentation module may further be configured to present the electronic file and/or the tracking data to the user via one or more web pages communicated via the communications channel 120. That is, the presentation module may be configured to permit the user to enter the identification data into a search field of a website and, in response, render the electronic file for viewing by the user via the webpage.

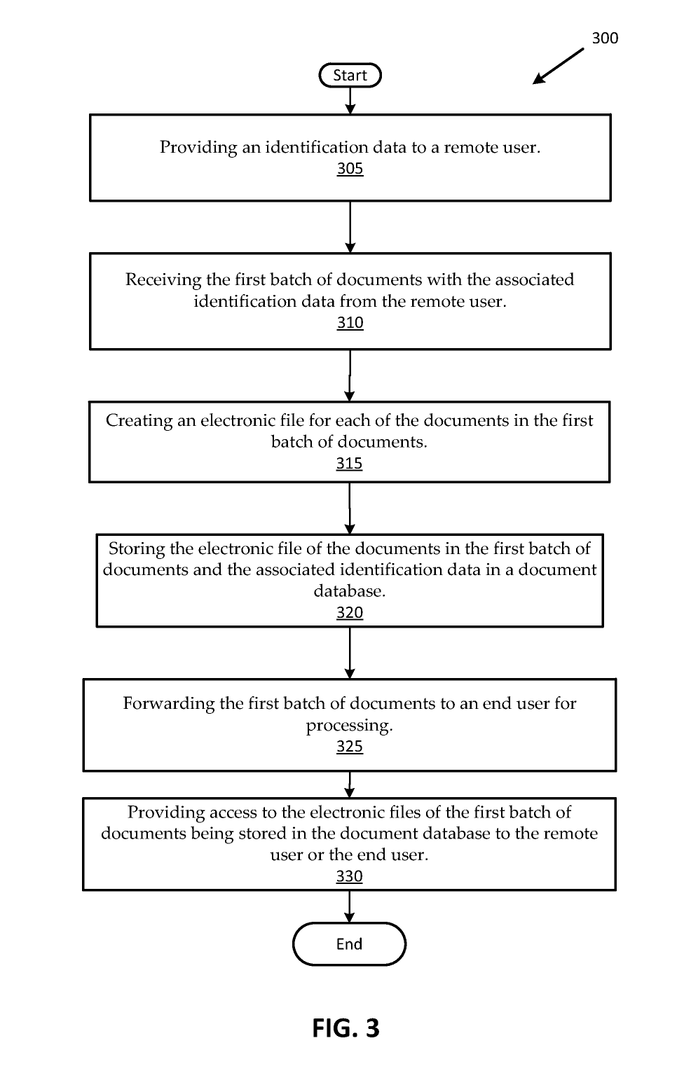

Referring now to FIG. 3, shown therein is a flowchart of an exemplary method 300 of providing document tracking and management. The method 300 may comprise a step 305 of providing an identification data to a remote user, e.g. the remote user 105. The identification data may be provided to the remote user via the communications channel 120. The identification data may be associated with a first batch of documents. The first batch of documents may include physical documents prepared by the remote user. In accordance with certain aspects, the identification data provided to the remote user is a barcode. The identification data may include information identifying the remote user and, optionally, identify a time period in which the remote user generated the first batch of documents. The remote user may attach, or otherwise associate the identification data with the first batch of documents. The first batch of documents may include a plurality of documents relating to the registration of one or more vehicles by the remote user for the predetermined time, e.g., a day. That is, the first batch of documents may include all of the documents that the remote user has generated or otherwise prepared on a business day for the title or registration of the vehicle, a recreational vehicle, a watercraft, etc.

The method 300 may further comprise a step 310 of receiving the first batch of documents with the associated identification data from the remote user. The first batch of documents with the associated identification data may be received by the first line provider 110. The first batch of documents with the associated identification data may be shipped from the remote user to the first line provider via the path 125. In accordance with certain aspects, the remote user may provide to the first line provider 110 a tracking number associated with first batch of documents being shipped such that the first line provider 110 can monitor and record receipt of the first batch of documents.

The method 300 may further comprise a step 315 of creating an electronic file for each of the documents in the first batch of documents. The electronic file may be associated with the identification data. The electronic file may be created by scanning each document of the first batch of documents using a scanner. Certain aspects may provide for utilization of an optical character recognition module to process each of the electronic files such that said files are word searchable. Processing the electronic files by the optical character recognition module may be completed contemporaneously at the initial creation of electronic files or performed as a subsequent step.

The method 300 may further comprise a step 320 of storing the electronic file of the documents in the first batch of documents and the associated identification data in a document database, e.g., the document database 215. The electronic files stored in the document database may be word searchable such that a user can locate and retrieve information contained in electronic files via a query module.

The method 300 and may also comprise a step 325 of forwarding the first batch of documents to an end-user for processing, e.g., the end user 115. Tracking data may include information indicative of the first batch of documents being forwarded to, and received by, the end user. The tracking data may be stored in the document database and associated with the identification data. The end user may be a DMV agency.

The method 300 and may comprise a step 330 of providing access to the electronic files of the first batch of documents being stored in the document database to the remote user or the end-user. The access may be provided via the communications channel, e.g., the communications channel 120. The remote user or end user may access the electronic files of the first batch of documents based on the identification data. For example, the remote user or the end-user may access the document database via the Internet and through one or more webpages configured to permit a user to enter the identification data associated with the first batch of documents so as to search the document database and retrieve the electronic file and/or the tracking data.

Alternate embodiments of the method 300 may provide for reviewing the first batch of documents received from the remote user to identify whether any document of the first batch of documents require a corrective action. Information indicative of the required corrective action may be communicated to the remote user via the communications channel. The first batch of documents may be reviewed by the first line provider to ensure compliance with state mandated regulations and procedures. For example, the first line provider may review the first batch of documents so as to ensure each required document necessary to register a vehicle is present and properly completed. In the case where the remote user is required to make a corrective action, the method 300 may further comprise receiving a correcting document from the remote user in response the remote user receiving the communicated corrective action. For example, when the review indicates that the first batch of documents includes a group of documents associated with the registration of the vehicle for a particular customer of the remote user wherein at least one of the documents is missing or improperly completed, the corrective action may notify the remote user such that the remote user can reconnect with the customer to remedy the incorrect registration documents. Once corrected, the remote user may forward the correcting document to the first line provider wherein the correcting document is further associated with the identification data so as to thereby remedy the previously identified corrective action.

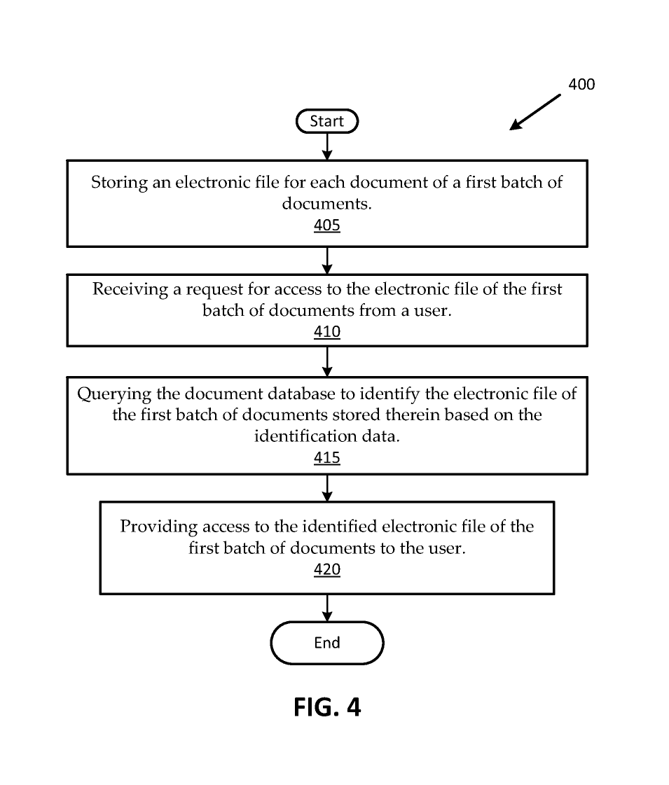

Turning now to FIG. 4, shown therein is alternate exemplary method 400 for providing document tracking and management. The method 400 may comprise a step 405 of storing an electronic file for each document of the first batch of documents. The electronic file may be stored in a document database, e.g. the document database 215. Each electronic file of the first batch of documents may be associated with the identification data. Tracking data for the first batch of documents is further stored in the document database and associated with the identification data.

The method 400 may also comprise a step 410 of receiving a request for access to the electronic file of the first batch of documents from a user. The user may be the remote user, or the end-user, e.g. a tag agent or the DMV agency. The request may be received via the communications channel e.g. the communications channel 120. The request may include the identification data that is associated with the first batch of documents.

The method 400 may also comprise a step 415 of querying the document database to identify the electronic file of the first batch of documents stored therein based on the identification data. For example, the user may enter the identification data into a webpage and then select the search button so as to activate a search function within the provider system 205. The method 400 and may utilize, for example, the query module of the applications module 215 discussed above.

Lastly, the method 400 may comprise a step 420 of providing access to the identified electronic file of the first batch of documents to the user. The access may be provided via the communications channel 120. As tracking data is also associated with the identification data, the user is also provided access to the tracking data for the first batch of documents. The user may access the electronic file and/or the tracking data via a web page being generated and presented to the user by the provider system 205.

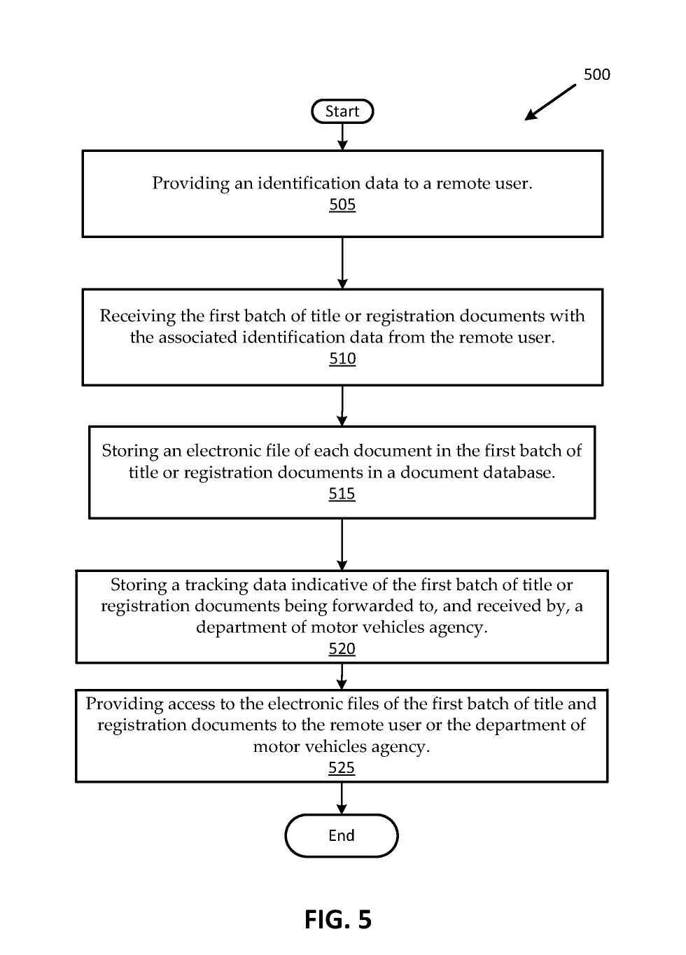

Turning now to FIG. 5, shown therein is an even further alternate embodiment of a method 500 of providing document tracking and management. The method 500 may comprise a step 505 of providing an identification data to remote user. The identification data may be associated with a first batch of title or registration documents. The identification data may be provided to the remote user via a communications channel e.g. the communications channel 120. The remote user may then associate the identification data with the first batch of title or registration documents. The remote user may be a tag agent.

The method 500 may further comprise a step 510 of receiving the first batch of title or registration documents with the associated identification data from the remote user. The first batch of title or registration documents may be received by the first line provider, e.g., the first line provider 110. The first line provider may record or otherwise document receipt of the first batch of title registration documents based on the associated identification data. For example, the first line provider may scan the identification data into the system 205 discussed above so as to store information associated with the first batch of title registration documents in the document database.

The method 500 may also comprise a step 515 of storing an electronic file of each document in the first batch of title or registration documents in a document database. Each of the documents of the first batch of title registration documents may be scanned by the first line provider so as to create and store the electronic file. The electronic file stored in the document database may include or otherwise be associated with the identification data.

The method 500 may even further comprise a step 520 of storing and tracking data indicative of the first batch of title registration documents being forwarded to, and received by, a Department of Motor Vehicles agency. For example, the first line provider may record and store in the document database a tracking data or a tracking number associated with the first batch of title registration documents being forwarded to the DMV agency. Information indicative of the DMV agency receiving the documents of the first batch of title and registration documents may also be stored in a document database and associated with the identification number as a component of the tracking data.

The method 500 may also comprise a step 525 of providing access to the electronic files of the first batch of title and registration documents to the remote user or the DMV agency. The access may be routed to the remote user or the DMV agency via the communications channel, e.g. the communications channel 120. The electronic files may be accessed via the remote user or the DMV agency based on the identification data. That is, the remote user or the DMV agency may access the electronic file of the first batch of title registration documents by entering the identification data into, for example, a webpage being provided by the provider system 205 of the first line provider 110 wherein the query module searches and returns the identified electronic file for presentation to the remote user or DMV agency.

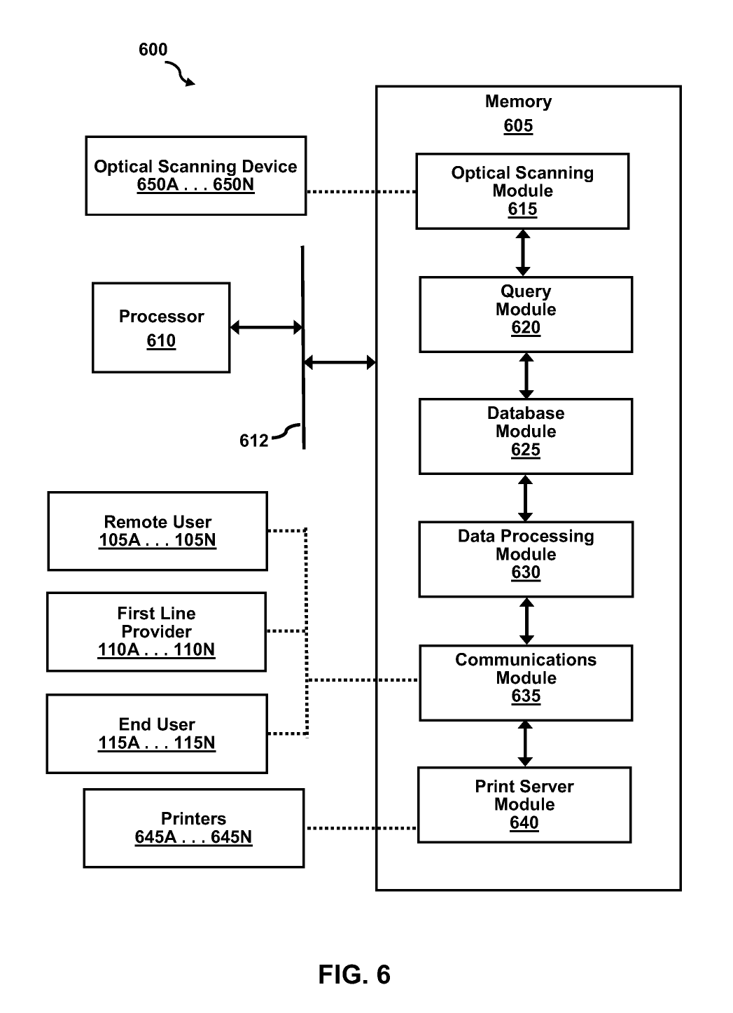

The system described above in relation to FIGS. 1 through 5 may further integrate into a system 600, as illustrated according to various embodiments in FIG. 6, for issuing license plates and registration cards for a recently purchased vehicle. The system 600 may comprise a memory 605 for storing executable instructions, and a processor 610 for executing the instructions stored in the memory 605. The processor 610 and the memory 605 may be coupled by a single bus 612, or by any other connection device or devices known in the art.

In various embodiments, the executable instructions in the memory 605 may comprise a plurality of modules. The modules may include a database module 625 configured to receive new and updated information, store and organize the information, and retrieve the information. The information stored in database module 625 may comprise information reported on a variety of documents used or required for the purchase of the vehicle. These documents may include an Application for Title or Registration, a Bill of Sale, an Odometer Disclosure Statement, a Smog Certification, a Safety inspection Certification, and the like. Specific data fields within the database may comprise a name of a registered owner of a recently purchased vehicle, a mailing address associated with the registered owner, a registration address associated with the registered owner, a license plate number, and a license plate identification sticker number. Specific data fields within the database may also comprise vehicle identification data such as the Vehicle Identification Number (VIN), the make, the model, the model year, and intended use such as personal, off-road, construction, and the like. Other specific data fields within the database may comprise information related to the sale of the vehicle, such as identifying information for a seller of the vehicle, fees (e.g., registration fees, license fees, sales tax) paid in relation to the sale of the vehicle, and approval of the fees from the DMV or other government agency. The database module 625 may comprise a relational database such that relationships between the data, such as which license plate number is assigned to which vehicle, as well as the Vehicle Identification Number associated with the vehicle, are maintained.

A data processing module 630 may also be present within the executable instructions that is communicatively coupled to the database module 625. The data processing module 630 may execute requests from a variety of users to enter data, retrieve data, analyze data, and handle other operational requests within the system 600. In various embodiments, the data processing module 630 may associate a set of data, the data being maintained in the database within the database module 625, with each of a plurality of recently purchased vehicles. The set of data may comprise a variety of data fields related to the purchased vehicles and the registered owners of the vehicles, including the name of the registered owner, a mailing address associated with the registered owner, a registration address associated with the registered owner, a license plate number, and a license plate identification sticker number.

The executable instructions may further comprise a communications module 635 communicatively coupled to the processing module 630. The communications module 635 may facilitate receiving and transmitting data within the system 600. The communications module 635 may be communicatively coupled to a plurality of users, such as remote users 105A-105N, first line providers 110A-110N, and end users 115A-115N (where N represents any number of the specific users) as described previously. The communications module 635 may receive data from and transmit data to the users 105, 110, 115. In various embodiments, the communications module 635 may be configured to operate on the Internet and communicate with a second communications module at a vehicle dealer (not shown) in order to receive vehicles sales information from the vehicle dealer transmitted by the second communications module.

In various embodiments, the executable instructions may comprise an optical scanning module 615. The optical scanning module 615 may be communicatively coupled to a plurality of optical scanning devices 650A-650N. The optical scanning devices 650 may be capable of reading a license plate number of a selected license plate using, but not limited to, optical character recognition. The license plate number may be stored in the database within the database module 630.

The optical scanning module 615 and the database module 625 may be communicatively coupled to a query module 620. According to various embodiments, the query module 620 may receive the license plate number optically read by an optical scanning device 650 from the optical scanning module 615. The query module 620 may determine the recently purchased vehicle and set of data associated with the license plate number. This association may be stored in the database.

The communications module 635 may also be communicatively coupled to a print server module 640. The print server module 640 may be communicatively coupled to a plurality of printers 645A-645N. The print server module 640 may direct the printers 645A-645N to print a set of documents associated with the recently purchased vehicle, and each individual printer 645 may be configured to print a specific document within the set of documents. For example, one printer 645 may print a registration card, one printer 645 may print a license plate identification sticker, and another printer 645 may print a mailing label.

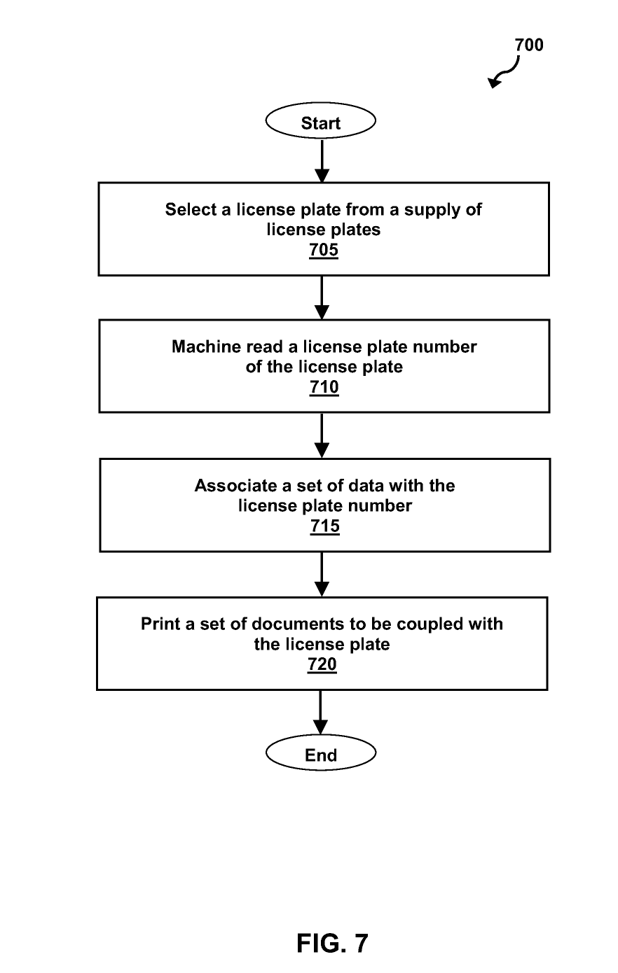

FIG. 7 is a flow chart of various embodiments of a method 700 for issuing a license plate and registration card for a vehicle using elements of the system 600 described previously. Method 700 may be carried out by a company or agency authorized to issue license plates and registration cards in response to vehicle sales. At step 705, a worker may select a license plate from a supply of license plates. The company or agency may be in possession of a supply of license plates that have been issued by the state (perhaps through a specific agency such as the DMV), but as of yet have not been associated with a specific vehicle. The worker at step 710 may position the selected license plate within range of an optical scanning device 650 that is capable of machine reading a license plate number on the selected license plate. The system 600 may then associate a set of data with the license plate number of the selected license plate at step 715. In various embodiments, the set of data may comprise identification information for a recently purchased vehicle, a name of a registered owner of the recently purchased vehicle, a mailing address associated with the registered owner, a registration address associated with the registered owner, and a license plate identification sticker number. At step 720, the system 600 may cause a set of documents to be printed by one or more of the printers 645A-645N. The set of documents may comprise a registration card, a license plate identification sticker, and a mailing label. In various embodiments, the set of documents may also comprise a month sticker signifying a month of a year in which registration is to be renewed.

Each of the set of documents may have a variety of data, obtained from the set of data stored in the database in the database module 625, printed thereon. For example, the data printed on the registration card may comprise identifying information for the recently purchased vehicle, the license plate number of the selected license plate, a name of the registered owner of the recently purchased vehicle, and a registration address associated with the registered owner. The license plate identification sticker may have a license plate identification sticker number printed on it. The license plate identification sticker number may be a unique alphanumeric code, such as the license plate number of the selected license plate. In addition, the license plate identification sticker may indicate a year in which registration is to be renewed. In various embodiments, the year may be pre-printed on the license plate identification sticker. The data printed on the mailing label may comprise the name of the registered owner and the mailing address of the registered owner which may be different than the registration address of the registered owner.

Once the set of documents is printed, the worker or an automated system may couple the selected license plate and the set of documents such as by placing them in an envelope, placing the mailing label on the envelope, and mailing or otherwise conveying the license plate and set of documents to the registered owner.

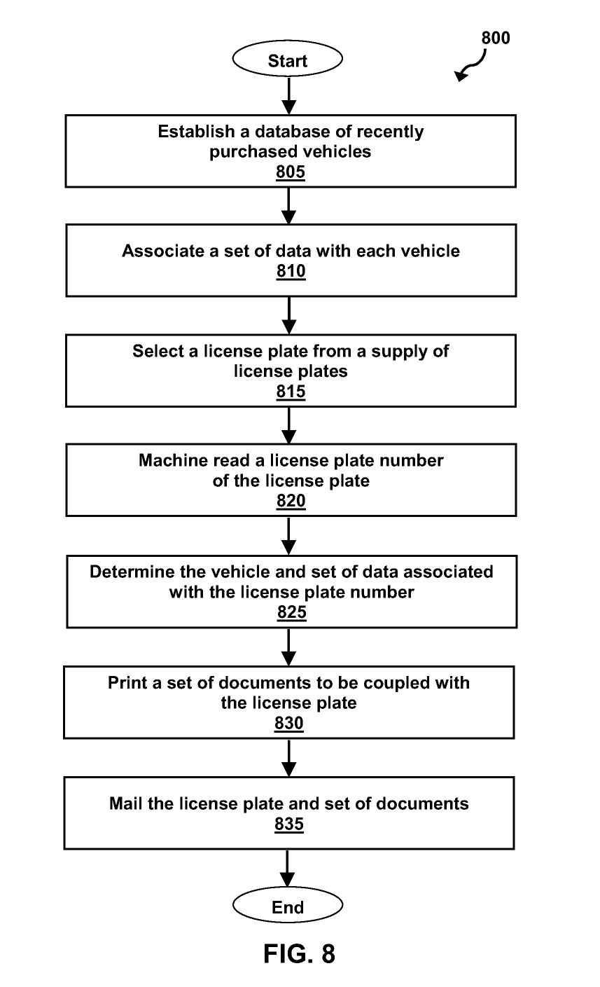

FIG. 8 is a flow chart of various embodiments of yet another method 800 for issuing a license plate and registration card for a vehicle using elements of the system 600 described previously. Method 800 may be carried out by a company or agency authorized to issue license plates and registration cards in response to vehicle sales. At step 805, a database of recently purchased vehicles may be established. The database of recently purchased vehicles may be transmitted to the system 600 via communications module 635 by one or more of the users 105, 110, 115. In various embodiments, the database of recently purchased vehicles may comprise vehicle sales information from vehicle dealers received by the system 600. As an intermediate step (not shown in FIG. 8) the vehicles sales information may be sent to a government agency for verification. The database of recently purchased vehicles may be stored in the database module 625. At step 810, the system 600 may associate a set of data with each of the recently purchased vehicles in the database. The set of data may comprise a name of a registered owner of the recently purchased vehicle, a mailing address associated with the registered owner, a registration address associated with the registered owner, a license plate number, and a license plate identification sticker number.

At step 815, a worker may select a license plate from a supply of license plates. The company or agency may be in possession of a supply of license plates that have been issued by the state (perhaps through a specific agency such as the DMV), but as of yet have not been associated with a specific vehicle. The worker at step 820 may position the selected license plate within range of an optical scanning device 650 that is capable of machine reading a license plate number on the selected license plate. The system 600 may then determine at step 825 which recently purchased vehicle within the database of recently purchased vehicles and the set of data that is associated with the license plate number of the selected license plate.

At step 830, the system 600 may cause a set of documents to be printed by one or more of the printers 645A-645N. The set of documents may comprise a registration card, a license plate identification sticker, and a mailing label. In various embodiments, the set of documents may also comprise a month sticker signifying a month of a year in which registration is to be renewed. Each of the set of documents may have a variety of data, obtained from the set of data stored in the database in the database module 625, printed thereon as described previously for method 700. In various embodiments, the print server module 640 may require that all the documents in a first set of documents be printed before printing any of the documents in a second set of documents. This procedure would avoid inadvertently mixing documents from different sets of documents when, for example, one of the printers 645 failed to print a document.

Once the set of documents is printed, the worker or an automated system at step 835 may couple the selected license plate and the set of documents such as by placing them in an envelope, placing the mailing label on the envelope, and mailing or otherwise conveying the license plate and set of documents to the registered owner.

According to some embodiments, the system 600 may include a cloud-based computing environment that collects, processes, analyzes, and publishes datasets. In general, a cloud-based computing environment is a resource that typically combines the computational power of a large grouping of processors and/or that combines the storage capacity of a large group of computer memories or storage devices. For example, systems that provide a cloud resource may be utilized exclusively by their owners, such as Google™ or Yahoo!™, or such systems may be accessible to outside users who deploy applications within the computing infrastructure to obtain the benefits of large computational or storage resources.

The cloud may be formed, for example, by a network of web servers with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depend upon the type of business associated with each user.

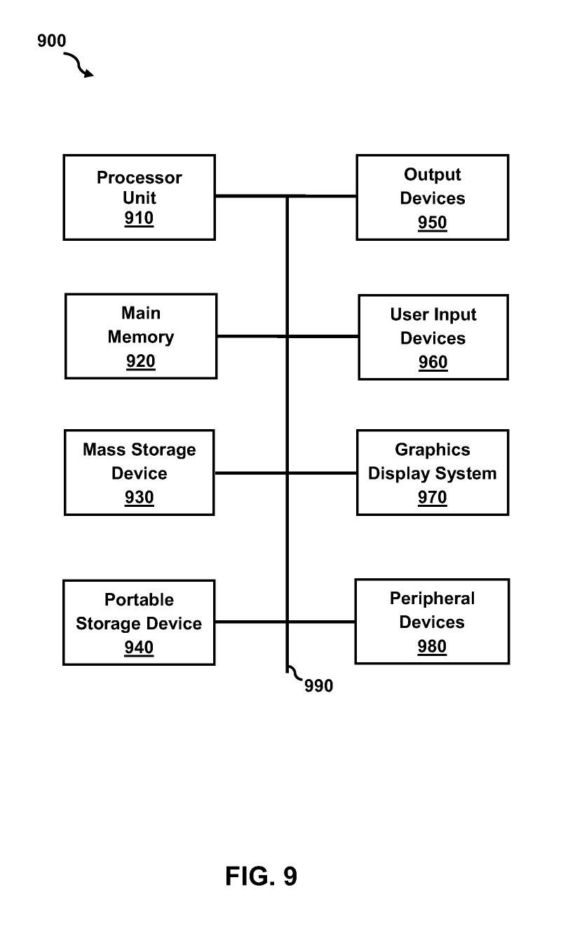

FIG. 9 illustrates an exemplary computing system 900 that may be used to implement an embodiment of the present technology. The computing system 900 of FIG. 9 includes one or more processor units 910 and main memory 920. Main memory 920 stores, in part, instructions and data for execution by processor 910. Main memory 920 can store the executable code when the system 900 is in operation. The system 900 of FIG. 9 may further include a mass storage device 930, portable storage device(s) 940, output devices 950, user input devices 960, a graphics display system 970, and other peripheral devices 980.

The components shown in FIG. 9 are depicted as being connected via a single bus 990. The components may be connected through one or more data transport means. Processor unit 910 and main memory 920 may be connected via a local microprocessor bus, and the mass storage device 930, peripheral device(s) 980, portable storage device(s) 940, and graphics display system 970 may be connected via one or more input/output (I/O) buses.

Mass storage device 930, which may be implemented with a magnetic disk drive or an optical disk drive, is a non-volatile storage device for storing data and instructions for use by processor unit 910. Mass storage device 930 can store the system software for implementing embodiments of the present technology for purposes of loading that software into main memory 920.

Portable storage device 940 operates in conjunction with a portable non-volatile storage media, such as a floppy disk, compact disk or digital video disc, to input and output data and code to and from the computer system 900 of FIG. 9. The system software for implementing embodiments of the present technology may be stored on such a portable media and input to the computer system 900 via the portable storage device 940.

User input devices 960 provide a portion of a user interface. User input devices 960 may include an alphanumeric keypad, such as a keyboard, for inputting alphanumeric and other information, or a pointing device, such as a mouse, a trackball, stylus, or cursor direction keys. Additionally, the system 900 as shown in FIG. 9 includes output devices 950. Suitable output devices include speakers, printers, network interfaces, and monitors.

Graphics display system 970 may include a liquid crystal display (LCD) or other suitable display device. Graphics display system 970 receives textual and graphical information, and processes the information for output to the display device.

Peripheral devices 980 may include any type of computer support device to add additional functionality to the computer system. Peripheral device(s) 980 may include a modem or a router.

The components contained in the computer system 900 of FIG. 9 are those typically found in computer systems that may be suitable for use with embodiments of the present technology and are intended to represent a broad category of such computer components that are well known in the art. Thus, the computer system 900 of FIG. 9 can be a personal computer, hand held computing system, telephone, mobile computing system, workstation, server, minicomputer, mainframe computer, or any other computing system. The computer may also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable media). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic media, a CD-ROM disk, digital video disk (DVD), any other optical media, any other physical media with patterns of marks or holes, a RAM, a PROM, an EPROM, an EEPROM, a FLASHEPROM, any other memory chip or data exchange adapter, a carrier wave, or any other media from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

The vehicles referenced in the description of the system 600 and the methods 700 and 800 may be any vehicle for which a government agency requires or requests registration. Exemplary vehicles include, but are not limited to, automobiles, trucks, recreational vehicles, motorhomes, motorcycles, airplanes, boats, personal watercrafts, all-terrain vehicles, bicycles, farm equipment, construction equipment, and trailers.

While the present invention has been described in connection with a series of preferred embodiments, these descriptions are not intended to limit the scope of the invention to the particular forms set forth herein. The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. The present descriptions are intended to cover such alternatives, modifications, and equivalents as may be included within the spirit and scope of the invention as defined by the appended claims and otherwise appreciated by one of ordinary skill in the art. In several respects, embodiments of the present invention may act to close the loopholes in the current industry practices in which good business practices and logic are lacking because it is not feasible to implement with current resources and tools.

What is claimed is:

1. A method for issuing a license plate and registration card for a vehicle, comprising:
selecting a license plate from a supply of license plates;
machine reading a license plate number of the selected license plate;
associating a set of data with the license plate number, the set of data comprising:
a recently purchased vehicle;
a name of a registered owner of the recently purchased vehicle;
a mailing address associated with the registered owner;
a registration address associated with the registered owner; and
a license plate identification sticker number; and
printing a set of documents to be coupled with the selected license plate, the set of documents comprising:
a registration card;
a license plate identification sticker; and
a mailing label.

2. The method of claim 1, wherein printing the registration card comprises printing the name of the registered owner, the registration address associated with the registered owner, and the license plate number on the registration card.

3. The method of claim 1, wherein printing the license plate identification sticker comprises printing the license plate identification sticker number on the license plate identification sticker.

4. The method of claim 1, wherein printing the mailing label comprises printing the mailing address associated with the registered owner on the mailing label.

5. The method of claim 1, further comprising printing all of the set of documents prior to printing any of the documents of a second set of documents.

6. The method of claim 1, wherein the license plate identification sticker signifies a year in which registration is to be renewed.

7. The method of claim 1, wherein the set of documents further comprises a month sticker signifying a month of a year in which registration is to be renewed.

8. The method of claim 1, wherein machine reading the license plate number comprises optically scanning the license plate and reading the license plate number using optical character recognition.

9. The method of claim 1, wherein the vehicle comprises an automobile, a truck, a recreational vehicle, a motorhome, a motorcycle, an airplane, a boat, a personal watercraft, an all-terrain vehicle, a bicycle, a piece of farm equipment, a piece of construction equipment, or a trailer.

10. The method of claim 1, further comprising mailing the license plate, registration card, and license plate identification sticker to the mailing address.

11. A method for issuing a license plate and registration card for a vehicle, comprising:
establishing a database of recently purchased vehicles;
associating a set of data with each of the recently purchased vehicles in the database, the set of data comprising:
a name of a registered owner of the recently purchased vehicle;
a mailing address associated with the registered owner;
a registration address associated with the registered owner;
a license plate number; and
a license plate identification sticker number;
selecting a license plate from a supply of license plates;
machine reading a license plate number of the selected license plate;
determining the recently purchased vehicle and set of data associated with the license plate number of the selected license plate;
printing a set of documents to be coupled with the selected license plate, the set of documents comprising:
a registration card;
a license plate identification sticker; and
a mailing label;
mailing the license plate, registration card, and license plate identification sticker to the mailing address.

12. The method of claim 11, wherein establishing a database of recently purchased vehicles comprises receiving vehicle sales information from vehicle dealers.

13. The method of claim 12, wherein establishing a database of recently purchased vehicles further comprises sending the vehicle sales information to a government agency for verification.

14. The method of claim 11, wherein printing the registration card comprises printing the name of the registered owner, the registration address associated with the registered owner, and the license plate number on the registration card.

15. The method of claim 11, wherein printing the license plate identification sticker comprises printing the license plate identification sticker number on the license plate identification sticker.

16. The method of claim 11, wherein printing the mailing label comprises printing the mailing address associated with the registered owner on the mailing label.

17. A system for issuing a license plate and registration card for a vehicle, comprising:
a processor;
a communications module;
a database configured to store information related to recently purchased vehicles;
a data processing module configured to associate a set of data with each of the recently purchased vehicles in the database, the set of data comprising:
a name of a registered owner of the recently purchased vehicle;
a mailing address associated with the registered owner;
a registration address associated with the registered owner;
a license plate number; and
a license plate identification sticker number;
an optical scanning module configured to operate an optical scanning device capable of reading a license plate number of a selected license plate using optical character recognition;
a query module configured to determine the recently purchased vehicle and set of data associated with the license plate number of the selected license plate in response to an input from the optical scanning module; and
a print server module configured to operate one or more printers to print a set of documents to be coupled with the selected license plate, the set of documents comprising:
a registration card;
a license plate identification sticker; and
a mailing label.

18. The system of claim 17, wherein the communications module is configured to operate on the Internet and communicate with a second communications module at a vehicle dealer.

19. The system of claim 18, wherein the second communications module transmits the information related to recently purchased vehicles to the communications module.

20. The system of claim 17, wherein the optical scanning module operates under instructions from the processor in response to an input from a user.
